(19) United States
(12) Patent Application Publication
(10) Pub. No.: US 2025/0236221 A1
(43) Pub. Date: Jul. 24, 2025

(54) VEHICLE SEAT

(71) Applicant: Honda Motor Co., Ltd., Tokyo (JP)

(72) Inventors: Shogo USUI, Tokyo (JP); Koji HASHIMOTO, Tokyo (JP); Masakazu OKADA, Tokyo (JP)

(73) Assignee: Honda Motor Co., Ltd., Tokyo (JP)

(21) Appl. No.: 18/970,947

(22) Filed: Dec. 6, 2024

(30) Foreign Application Priority Data
Jan. 23, 2024 (CN) 202410092863.X

(51) Int. Cl. B60N 2/22

(52) U.S. Cl. CPC B60N 2/22; B60N 2002/2204

(57) ABSTRACT

A vehicle seat includes an electric device for moving a seat cushion and a seat back to a predetermined posture. The vehicle seat includes a detection device for detecting a tilt degree of a vehicle. When the electric device moves the seat cushion and the seat back to the predetermined posture, if the vehicle is tilted rearward, the seat cushion is moved so that the seat cushion is tilted forward compared to the seat cushion when the vehicle is in the predetermined posture, and if the vehicle is tilted forward, the seat cushion is moved so that the seat cushion is tilted rearward compared to the seat cushion when the vehicle is in the predetermined posture.

### CROSS-REFERENCE TO RELATED APPLICATION

This application claims the priority benefit of China application serial no. 202410092863.X, filed on Jan. 23, 2024. The entirety of the above-mentioned patent application is hereby incorporated by reference herein and made a part of this specification.

### BACKGROUND

### Technical Field

The disclosure relates to a seat, and in particular relates to a vehicle seat.

### Description of Related Art

In recent years, efforts have been actively made to provide access to sustainable transportation systems for those in vulnerable positions, such as the elderly or children. In order to achieve the above-mentioned purpose, research and development are devoted to further improving the safety and convenience of traffic through developments related to the vehicle seats.

In the past, when the memory seat of the driver's seat or the electric seat of the front passenger seat tilts, if the passenger feels that the seat position is uncomfortable, the usual practice is for the passenger to adjust the seat manually to relieve the discomfort. There has been a notable absence of systems capable of automatically compensating for the discomfort caused by tilt.

Patent Document 1 (Japanese Laid Open Utility Model No. 05-080863) discloses a method of maintaining the seat level regardless of how the vehicle body is tilted, but does not take into consideration the seat angle at which passengers feel comfortable.

### SUMMARY

A vehicle seat is provided in the disclosure, the vehicle seat includes an electric device for moving a seat cushion and a seat back to a predetermined posture. The vehicle seat includes a detection device for detecting a tilt degree of a vehicle. When the electric device moves the seat cushion and the seat back to the predetermined posture, if the vehicle is tilted rearward, the seat cushion is moved so that the seat cushion is tilted forward compared to the seat cushion when the vehicle is in the predetermined posture, and if the vehicle is tilted forward, the seat cushion is moved so that the seat cushion is tilted rearward compared to the seat cushion when the vehicle is in the predetermined posture.

In order to make the aforementioned and other features and advantages of the disclosure comprehensible, embodiments accompanied with drawings are described in detail below.

### BRIEF DESCRIPTION OF THE DRAWINGS

FIG. 1 is a block diagram of a vehicle seat according to an embodiment of the disclosure.

FIG. 2 is a flowchart of an operation method of a vehicle seat according to an embodiment of the disclosure.

FIG. 3 is a flowchart of an operation method of a vehicle seat according to an embodiment of the disclosure.

FIG. 4 is an example of a vehicle seat operating method according to an embodiment of the disclosure.

### DETAILED DESCRIPTION OF DISCLOSED EMBODIMENTS

Hereinafter, embodiments of the disclosure are described with reference to the drawings.

As for vehicle seats, current technology cannot automatically adjust the seats in tilted vehicles to an angle that passengers find comfortable. Therefore, the challenge lies in how to adjust the seats based on the tilt degree of the vehicle and the predetermined posture of the passenger.

In order to solve the above-mentioned challenge, this disclosure changes the memory posture according to the tilt level of the vehicle, and aims to reduce the burden caused by the tilt of the vehicle to patients and the elderly. Moreover, it further contributes to the development of sustainable transportation systems.

In one aspect of the vehicle seat of the disclosure, the electric device moves the seat back to an angle relative to the seat cushion in which the seat back is in the predetermined posture.

In this disclosure, tilt sensor information is used to move the memory seat of the driver's seat or the electric seats of other passengers to a pre-memorized relaxation position. When there are patients or elderly people waiting to lie down and the vehicle is parked on a slope, the tilt sensor information is used to correct the seat to the same angle as when gravity is relatively flat, thus providing a relaxation position that is not affected by the tilt of the vehicle. In addition, it can also reduce the burden caused by the tilted vehicle state for patients and the elderly.

In the embodiment of the disclosure, tilt sensor information is used to move the memory seat of the driver's seat or the electric seats of other passengers to a pre-memorized relaxation position. When the vehicle is parked on a slope, the information of the tilt sensor is used for calculation, the seat is automatically laid-down, tilted, or raised to correct the seat to the same angle as when gravity is relatively flat, thereby providing a relaxation position that is not affected by the tilt of the vehicle.

In addition, if the electric seat of the passenger is lying down or tilted, and there is a patient or elderly person lying thereon, regardless of whether the vehicle is stationary or in motion, should a tilting situation occur, the embodiment of the disclosure utilizes information from a tilt sensor to perform calculations and automatically adjusts the lying, tilting, and height of the seat, such that it maintains a position relative to gravity that is equivalent to when it is in a flat state. As a result, it can also reduce the burden caused by the tilted vehicle for patients and the elderly.

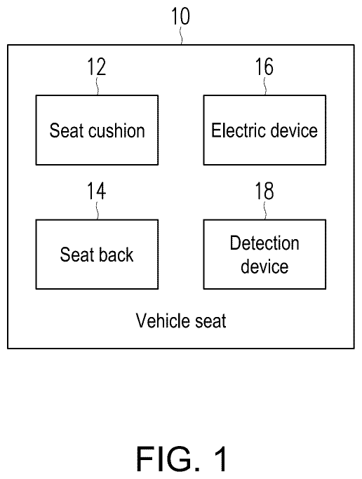

FIG. 1 is a block diagram of a vehicle seat according to an embodiment of the disclosure. Referring to FIG. 1, the vehicle seat 10 of this embodiment is, for example, installed or configured in a vehicle (not shown) to detect the tilt of the vehicle and adjust the lying, tilting and height of the seat according to the detection results. In this embodiment, the vehicle is, for example, a car using an internal combustion engine such as a diesel engine or a gasoline engine as a power source, an electric car using an electric motor as a power source, or a hybrid car having both an internal combustion engine and an electric motor, which is not limited thereto.

The vehicle seat 10 includes a seat cushion 12, a seat back 14, an electric device 16 for moving the seat cushion and the seat back to a predetermined posture, and a detection device 18 for detecting the tilt degree of the vehicle. In some embodiments, the vehicle seat 10 is, for example, the seat of the driver seat or the seat of the passenger, which is not limited thereto.

The electric device 16 is, for example, a motor controlled using a relay or an integrated circuit (IC). The speed of the motor is controlled through pulse-width modulation (PWM), thereby achieving smooth operation of the motor and smooth movement of the vehicle seat 10. The movement of the vehicle seat 10 includes sliding forward and rearward, raising and descending, tilting forward and rearward of the seat cushion 12 and lying down of the seat back 14, etc., which is not limited thereto.

The detection device 18 is, for example, a tilt sensor, which includes an acceleration sensor and a speed sensor (angular velocity sensor) such as gyro sensors. By performing predetermined measurement calculation processing on the detection signals of these sensors, the “tilt degree (direction and angle) relative to the gravity direction” of the portion (vehicle body) where the tilt sensor is located can be obtained.

In some embodiments, the vehicle seat 10 also includes a processing device (not shown) for controlling the operation of the electric device 16 and the detection device 18. The processing device is implemented, for example, by executing a program through a processor such as an electronic control unit (ECU) or a central processing unit (CPU), or through hardware such as large scale integration (LSI), application specific integrated circuit (ASIC), or field programmable gate array (FPGA). Furthermore, it may be implemented through a combination of software and hardware. This embodiment does not limit its implementation.

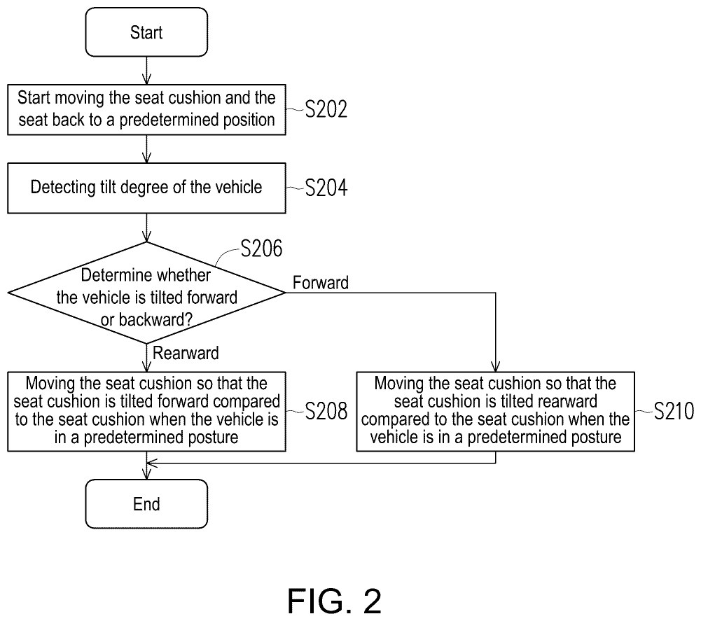

FIG. 2 is a flowchart of an operation method of a vehicle seat according to an embodiment of the disclosure. Referring to FIG. 1 and FIG. 2 at the same time, the vehicle seat operating method of this embodiment is applicable to the vehicle seat 10 of FIG. 1 to adjust the posture of the vehicle seat 10. Detailed steps of the vehicle seat operating method of this embodiment is described below with reference to each component in the vehicle seat 10.

In step S202, the vehicle seat 10 starts to move the seat cushion 12 and the seat back 14 to a predetermined posture through the electric device 16. The predetermined posture is, for example, a posture that the driver or passenger has adjusted in advance to feel comfortable or relaxed, which includes the position and angle of the seat cushion 12 and the seat back 14.

The predetermined posture is, for example, stored in a storage device built into the vehicle seat 10, so that when the passenger gets on the vehicle, the vehicle seat 10 can automatically adjust to a posture that the passenger finds comfortable. The storage device is, for example, a device such as random access memory (RAM), read only memory (ROM) or/and electrically erasable programmable read only memory (E2PROM), etc. This embodiment does not limit its implementation.

In step S204, the vehicle seat 10 uses the detection device 18 to detect the tilt degree of the vehicle, and in step S206, it is determined whether the vehicle is tilted forward or rearward according to the detected tilt degree.

When it is determined that the vehicle is tilted rearward, in step S208, the vehicle seat 10 moves the seat cushion 12 through the electric device 16 so that the seat cushion 12 is tilted forward compared to the seat cushion 12 when the vehicle is in the predetermined posture.

When it is determined that the vehicle is tilted forward, in step S210, the vehicle seat 10 moves the seat cushion 12 through the electric device 16 so that the seat cushion 12 is tilted rearward compared to the seat cushion 12 when the vehicle is in the predetermined posture.

Through the above method, the vehicle seat 10 of this embodiment can consider the current tilt degree of the vehicle and provide feedback to the adjustment of the tilting of the seat cushion 12 during the process of adjusting the seat cushion 12 and the seat back 14 to a predetermined posture that the passenger feels comfortable, so that the tilting of the seat cushion 12 after adjustment is the same as when the gravity is relatively flat.

In some embodiments, in addition to adjusting the seat cushion 12, the vehicle seat 10 further moves the seat back 14 to an angle of the seat back in a predetermined posture relative to the seat cushion through the electric device 16.

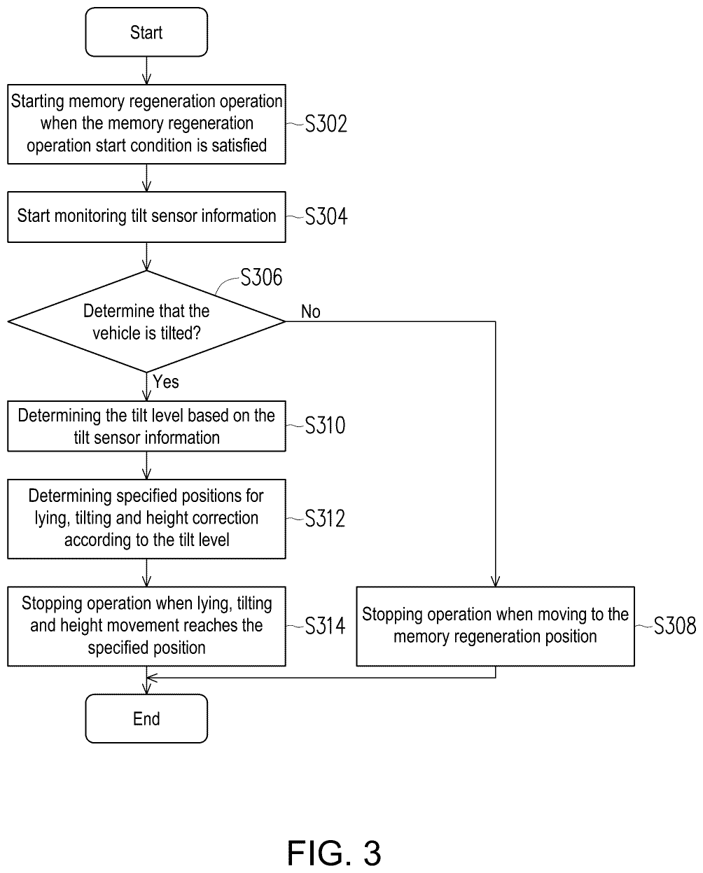

In detail, FIG. 3 is a flowchart of an operation method of a vehicle seat according to an embodiment of the disclosure. Referring to FIG. 1 and FIG. 3 at the same time, the vehicle seat operating method of this embodiment is applicable to the vehicle seat 10 of FIG. 1 to adjust the posture of the vehicle seat 10. Detailed steps of the vehicle seat operating method of this embodiment is described below with reference to each component in the vehicle seat 10.

In step S302, the vehicle seat 10 starts the memory regeneration operation when the memory regeneration operation start condition is satisfied. The memory regeneration operation refers to controlling the electric device 16 to adjust the position and angle of the seat cushion 12 and the seat back 14 according to the pre-stored predetermined postures of the seat cushion 12 and the seat back 14.

The starting condition of the memory regeneration operation includes detecting the operation of the memory seat switch, but not limited thereto. In some embodiments, the starting condition for the memory regeneration operation also includes detection of vehicle door unlocking, detection of vehicle key approach, detection of button signal of remote key (FOB key), detection of the driver sitting in the driver's seat, detection of the vehicle ignition starting, etc., which is not limited thereto.

In step S304, the vehicle seat 10 starts to monitor the tilt sensor information, which includes using the detection device 18 to detect the tilt degree of the vehicle, and receiving the information obtained by the detection device 18 detecting the tilt degree of the vehicle to perform monitoring.

In step S306, the vehicle seat 10 determines whether the vehicle is tilted according to the tilt sensor information. If it is determined that the vehicle is not tilted, the vehicle seat 10 continues to perform the memory regeneration operation until, in step S308, when the seat cushion 12 and the seat back 14 move to the memory regeneration position, the memory regeneration operation is stopped.

On the contrary, in step S306, if it is determined that the vehicle is tilted, then in step S310, the vehicle seat 10 determines the tilt level according to the tilt sensor information, so that in step S312, the lying, tilting and height correction are determined according to the tilt level, and the memory regeneration operation is continued based on the corrected specified position until, in step S314, when the seat cushion 12 and the seat back 14 move to the corrected specified position, the memory regeneration operation is stopped.

Through the above method, the vehicle seat 10 of this embodiment automatically determines the tilt level to correct the lying, tilting and height of the seat cushion 12 and the seat back 14 when the vehicle is tilted, regardless of whether the vehicle is stopped or running, such that the seat cushion 12 and the seat back 14 maintain a position relative to gravity that is equivalent to when it is in a flat state. As a result, it can also reduce the burden caused by the tilted vehicle for patients and the elderly.

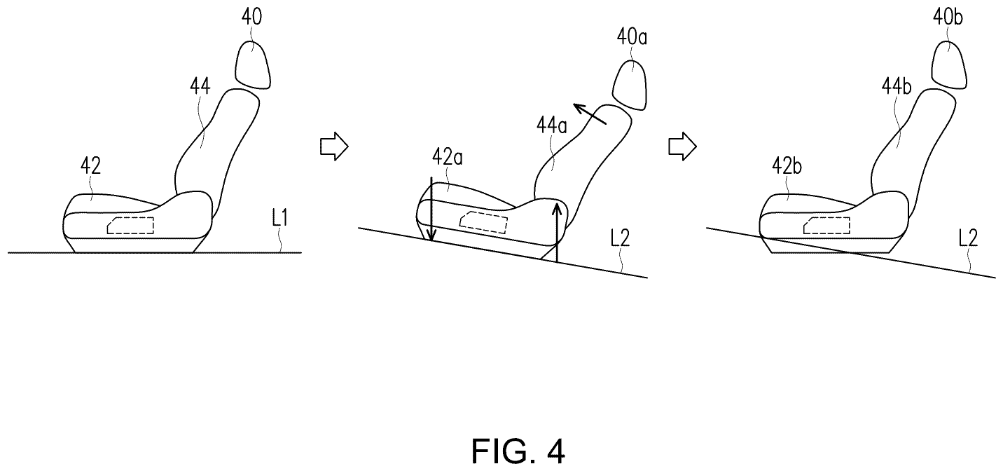

FIG. 4 is an example of a vehicle seat operating method according to an embodiment of the disclosure. Referring to FIG. 4, in this embodiment, when the vehicle is in a flat state (the tilt degree of the vehicle body plane L1 is zero), the position and angle of the seat cushion 42 and seat back 44 as adjusted by the passenger for comfort while seated in the vehicle seat 40 are memorized.

When the vehicle is in a tilted state (the tilt degree of the vehicle body plane L2 is greater than zero), this embodiment corrects the lying, tilting, and height of the seat cushion 42a and the seat back 44a of the tilted vehicle seat 40a according to the detected tilt degree information. This includes adjusting the tilted seat cushion 42a to tilt forward compared to the seat cushion 42 when the vehicle is not tilted (front edge lowers and rear edge rises as shown in the figure), and moving the tilted seat back 44a to the angle of the seat back 44 relative to the seat cushion 42 when the vehicle is not tilted (tilted forward as shown in the figure).

Through the above adjustments and movements, this embodiment can enable the lying, tilting, and height of the seat cushion 42b and the seat back 44b in the adjusted vehicle seat 40b to be equivalent to the lying, tilting, and height of the seat cushion 42 and the seat back 44 when the gravity is relatively flat (i.e., in a flat state). As a result, it can also reduce the burden caused by the tilted vehicle for patients, the elderly, or other passengers.

To sum up, the vehicle seat according to the embodiment of the disclosure uses tilt sensor information to move the memory seat of the driver's seat or the electric seats of other passengers to a pre-memorized relaxation position. When there are patients or elderly people waiting to lie down and the vehicle is parked on a slope, the tilt sensor information is used to correct the seat to the same angle as when gravity is relatively flat, thus providing a relaxation position that is not affected by the tilt of the vehicle. In addition, it can also reduce the burden caused by the tilted vehicle state for patients and the elderly.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A vehicle seat, the vehicle seat comprising an electric device for moving a seat cushion and a seat back to a predetermined posture, comprising:
a detection device, detecting a tilt degree of a vehicle, wherein
when the electric device moves the seat cushion and the seat back to the predetermined posture,
if the vehicle is tilted rearward, the seat cushion is moved so that the seat cushion is tilted forward compared to the seat cushion when the vehicle is in the predetermined posture; and
if the vehicle is tilted forward, the seat cushion is moved so that the seat cushion is tilted rearward compared to the seat cushion when the vehicle is in the predetermined posture.

2. The vehicle seat according to claim 1, wherein
the electric device moves the seat back to an angle relative to the seat cushion in which the seat back is in the predetermined posture.
